(19) United States
(12) Patent Application Publication
(10) Pub. No.: US 2025/0093568 A1
(43) Pub. Date: Mar. 20, 2025

(54) SYSTEMS AND METHODS FOR LIGHT RECYCLING USING POLARIZATION AT AN INCOUPLER AND A REFLECTIVE STRUCTURE

(71) Applicant: GOOGLE LLC, Mountain View, CA (US)

(72) Inventors: Daniel Adema, Kitchener (CA); Shreyas Potnis, Kitchener (CA); Timothy Paul Bodiya, Toronto (CA)

(21) Appl. No.: 18/728,360

(22) PCT Filed: Jul. 21, 2022
(86) PCT No.: PCT/US2022/037812

§ 371 Date: Jul. 11, 2024

Related U.S. Application Data
(60) Provisional application No. 63/298,318, filed on Jan. 11, 2022.

(51) Int. Cl. F21V 8/00

(52) U.S. Cl. CPC G02B 6/0018; G02B 6/0016; G02B 6/0056

(57) ABSTRACT

The present disclosure describes techniques for reflecting light incoupled into a waveguide in a direction away from the outcoupler back toward the outcoupler. The waveguide includes an incoupler to incouple light of a first polarization state, and a reflective structure to receive incoupled light of the first polarization state and reflect it with a second polarization state toward the outcoupler. The reflective structure is on an opposite side of the incoupler as the outcoupler. In some embodiments, a polarization beam splitter or other polarization-selective layer is included at an interface of the incoupler and a waveguide substrate of the waveguide to transmit light of the first polarization state and reflect light of the second polarization state.

### BACKGROUND

In a conventional wearable heads-up display (WHUD), light beams from an image source are coupled into a light guide substrate, generally referred to as a waveguide, by an input optical coupling such as an in-coupling diffraction grating (i.e., an “incoupler”), which can be formed on a surface of the substrate or buried within the substrate. Once the light beams have been coupled into the waveguide, the light beams are “guided” through the substrate, typically by multiple instances of total internal reflection (TIR) to then be directed out of the waveguide by an output optical coupling (i.e., an “outcoupler”), which can also take the form of a diffractive optic. The light beams ejected from the waveguide overlap at an eye relief distance from the waveguide forming an exit pupil within which a virtual image generated by the image source can be viewed.

### SUMMARY

The present disclosure describes embodiments for reflecting light incoupled into a waveguide in a direction away from the outcoupler back toward the outcoupler. The amount of incoupled light that is ultimately provided to the outcoupler of the waveguide is thereby increased, improving the quality of the image provided to the user.

In one example embodiment, a waveguide includes an incoupler to incouple light of a first polarization state, and a reflective structure to receive incoupled light of the first polarization state and reflect it with a second polarization state toward an outcoupler.

In certain embodiments, the reflective structure of the waveguide is on an opposite side of the incoupler as the outcoupler. In certain embodiments, the incoupler transmits light of the first polarization state and reflects light of the second polarization state. In other embodiments, the waveguide further includes a polarization beam splitter layer at an interface between the incoupler and a waveguide substrate of the waveguide. The polarization beam splitter layer, for example, transmits light of the first polarization state and reflects light of the second polarization state.

In some embodiments, the reflective structure of the waveguide includes a diffractive grating with a fractional pitch of a grating of the incoupler. For example, the fractional pitch is half of a pitch. The diffractive grating, in some embodiments, is on a same surface of a waveguide substrate of the waveguide as the incoupler. In other embodiments, the reflective structure of the waveguide includes a prism. For example, the prism is a right-angle prism with mirrored internal surfaces. In other embodiments, the reflective structure of the waveguide includes a mirror.

In some embodiments, the reflective structure of the waveguide also includes a waveplate to convert light of the first polarization state to the second polarization state. In some embodiments, the incoupler of the waveguide is a binary diffractive incoupler grating.

In another example embodiment, a method includes incoupling, via an incoupler, light of a first polarization state into a waveguide; and receiving, at a reflective structure, incoupled light of the first polarization state and reflecting it with a second polarization state toward an outcoupler. In some embodiments, the reflective structure is on an opposite side of the incoupler as the outcoupler

The method further includes, in some embodiments, converting the incoupled light of the first polarization state to the second polarization state via a waveplate in the reflective structure. In some embodiments, the method further includes reflecting light of the second polarization state at an interface of the incoupler and a waveguide substrate of the waveguide. For example, in some embodiments, the incoupler is a binary diffractive incoupler grating.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system having a support structure that houses a projection system configured to project images toward the eye of a user, in accordance with some embodiments.

FIG. 2 shows an example of a block diagram of a projection system that projects light representing images onto the eye of a user via a display system, such as the display system of FIG. 1, in accordance with some embodiments.

FIG. 3 shows an example of light propagation within a waveguide of a laser projection system, such as the projection system of FIG. 2, in accordance with some embodiments.

FIG. 4 shows an example of a top view of a portion of a waveguide including an incoupler grating and reflective structure including a mirror and a magnified view, in accordance with some embodiments.

FIG. 5 shows another example of a top view of a portion of a waveguide including an incoupler grating and a reflective structure including a prism, in accordance with some embodiments.

FIG. 6 shows a side view corresponding to FIG. 6, in accordance with some embodiments.

FIG. 7 shows another example of a top view of a portion of a waveguide including an incoupler grating and a reflective structure including diffractive grating with ½ pitch with respect to the incoupler grating, in accordance with some embodiments.

FIG. 8 shows a side view corresponding to FIG. 8, in accordance with some embodiments.

FIG. 9 shows an example of a flowchart, in accordance with some embodiments.

### DETAILED DESCRIPTION

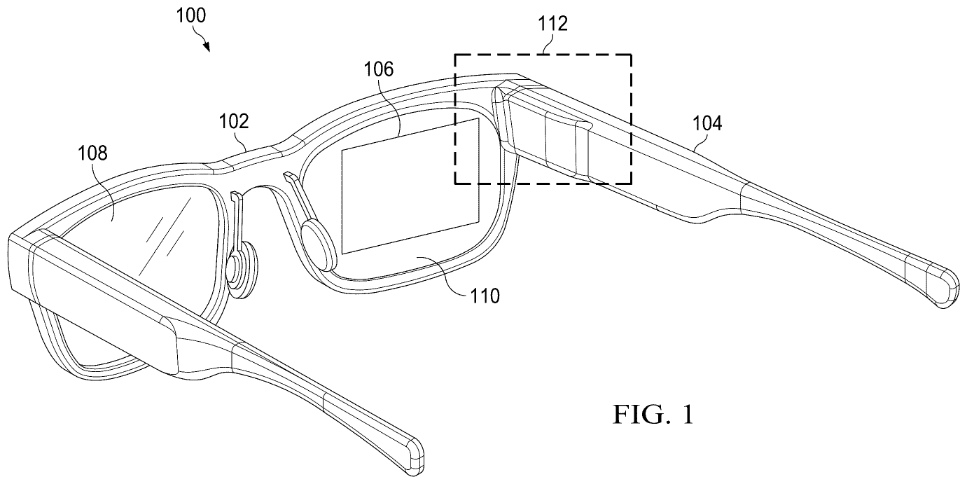

Inefficient transmission of received light through a waveguide of a WHUD can result in poor image quality at a user's eye, and thus generally be detrimental to the user experience. One source of such inefficiency is the transmission of light away from an outcoupler of the waveguide. FIGS. 1-9 illustrate techniques for including a reflective structure in the waveguide to reflect light from one portion of the waveguide (e.g., one end of the waveguide) towards an outcoupler at a different portion of the waveguide (e.g., at an opposite end). The amount of incoupled light that is ultimately provided to the outcoupler is thereby increased, improving the quality of the image provided to the user.

To illustrate, in some embodiments, the waveguide includes an incoupler, such as a binary diffractive grating incoupler, that transmits a first portion (referred to as the primary portion) of incoming light towards the waveguide outcoupler and a second portion of light away from the outcoupler. A reflective structure is placed at a location of the waveguide so that the second portion is reflected back toward the outcoupler (this reflected light is referred to as the recycled portion), thus increasing the overall proportion of the incoming light that is provided to the outcoupler. This in turn increases the quality of the resulting image viewed by the user.

In some cases, the recycled portion may be reflected such that the reflected light strikes the incoupler. To prevent the recycled portion from interacting with the incoupler and being prematurely outcoupled, in some embodiments the waveguide includes optical structures to change the polarization state of the reflected portion. To illustrate, in some embodiments the reflective structure includes a waveplate or other optical structure so that the recycled portion is reflected with a different polarization state (e.g., a second polarization state) than the original polarization state (e.g., a first polarization state) of the light that was incoupled into the waveguide substrate. Furthermore, a selective polarization layer is provided at an interface between the incoupler and the waveguide substrate or directly within the incoupler, thereby preventing the reflected portion from exiting the waveguide at the incoupler. For example, in some embodiments the selective polarization layer is a polarization beam splitter (PBS) formed as a dielectric layer that transmits light of the original polarization state (e.g., the first polarization state) and reflects light of the different polarization state (e.g., the second polarization state). In this manner, the selective polarization layer reflects the recycled portion with the different polarization state so that it does not interact with the incoupler while still allowing the incoupler to incouple the input light of the original polarization state into the waveguide.

FIGS. 1-9 illustrate embodiments of an example display system and techniques to reduce light loss from a waveguide, as described in greater detail below. However, it will be appreciated that the apparatuses and techniques of the present disclosure are not limited to implementation in this particular display system, but instead may be implemented in any of a variety of display systems using the guidelines provided herein.

FIG. 1 illustrates an example display system 100 having a support structure 102 that includes an arm 104, which houses a laser projection system configured to project images toward the eye of a user, such that the user perceives the projected images as being displayed in a field of view (FOV) area 106 of a display at one or both of lens elements 108, 110. In the depicted embodiment, the display system 100 is a wearable heads-up display (WHUD) that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a laser projector, an optical scanner, and a waveguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, laser light used to form a perceptible image or series of images may be projected by a laser projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler of the waveguide to an outcoupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In some embodiments, the projector is a digital light processing-based projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, the projector routes light via first and second scan mirrors, an optical relay disposed between the first and second scan mirrors, and a waveguide disposed at the output of the second scan mirror. In some embodiments, at least a portion of an outcoupler of the waveguide may overlap the FOV area 106. In at least some embodiments, the waveguide includes a reflective structure to reflect a recycled portion of incoupled light, so that the reflected portion is directed towards the outcoupler. The outcoupler of the waveguide outcouples the primary portion of light that is propagated through the waveguide from the incoupler and the recycled portion of light that is reflected back into the waveguide by the reflective structure. In this manner, the outcoupler outcouples an increased amount of light to generate the FOV area 106. In some embodiments, the primary portion has a first polarization state, and the recycled portion has a second polarization state, thereby preventing the reflected portion from exiting the waveguide at the incoupler. These aspects are described in greater detail below.

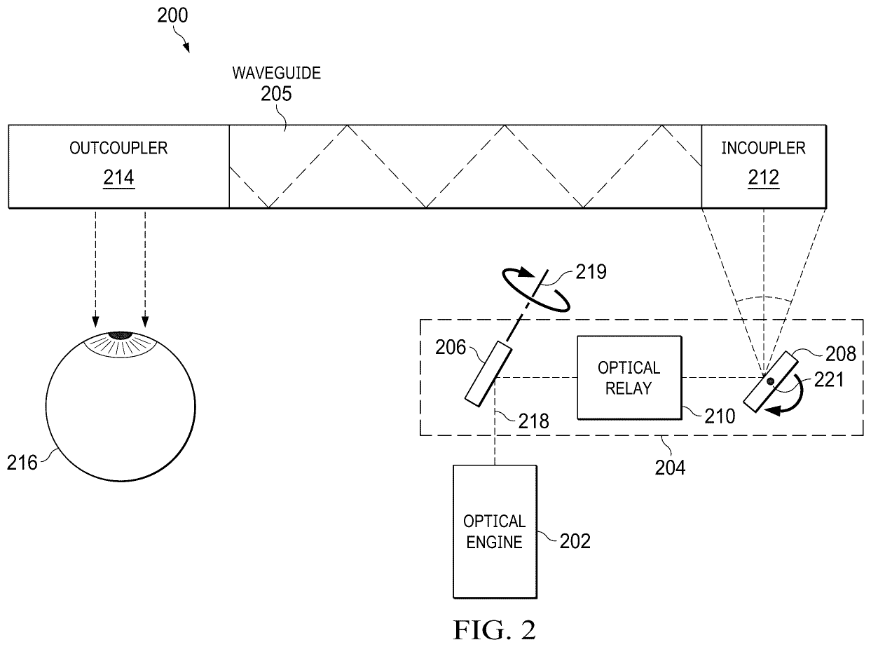

FIG. 2 illustrates a simplified block diagram of a laser projection system 200 that projects images directly onto the eye of a user via laser light. The laser projection system 200 includes an optical engine 202, an optical scanner 204, and a waveguide 205. The optical scanner 204 includes a first scan mirror 206, a second scan mirror 208, and an optical relay 210. The waveguide 205 includes an incoupler 212 and an outcoupler 214, with the outcoupler 214 being optically aligned with an eye 216 of a user in the present example. In some embodiments, the laser projection system 200 is implemented in a wearable heads-up display or other display system, such as the display system 100 of FIG. 1.

The optical engine 202 includes one or more laser light sources configured to generate and output laser light 218 (e.g., visible laser light such as red, blue, and green laser light and/or non-visible laser light such as infrared laser light). In some embodiments, the optical engine 202 is coupled to a driver or other controller (not shown), which controls the timing of emission of laser light from the laser light sources of the optical engine 202 in accordance with instructions received by the controller or driver from a computer processor coupled thereto to modulate the laser light 218 to be perceived as images when output to the retina of an eye 216 of a user.

For example, during the operation of the laser projection system 200, multiple laser light beams having respectively different wavelengths are output by the laser light sources of the optical engine 202, then combined via a beam combiner (not shown), before being directed to the eye 216 of the user. The optical engine 202 modulates the respective intensities of the laser light beams so that the combined laser light reflects a series of pixels of an image, with the particular intensity of each laser light beam at any given point in time contributing to the amount of corresponding color content and brightness in the pixel being represented by the combined laser light at that time.

One or both of the scan mirrors 206 and 208 of the optical scanner 204 are MEMS mirrors in some embodiments. For example, the scan mirror 206 and the scan mirror 208 are MEMS mirrors that are driven by respective actuation voltages to oscillate during active operation of the laser projection system 200, causing the scan mirrors 206 and 208 to scan the laser light 218. Oscillation of the scan mirror 206 causes laser light 218 output by the optical engine 202 to be scanned through the optical relay 210 and across a surface of the second scan mirror 208. The second scan mirror 208 scans the laser light 218 received from the scan mirror 206 toward an incoupler 212 of the waveguide 205. In some embodiments, the scan mirror 206 oscillates along a first scanning axis 219, such that the laser light 218 is scanned in only one dimension (i.e., in a line) across the surface of the second scan mirror 208. In some embodiments, the scan mirror 208 oscillates or otherwise rotates along a second scanning axis 221. In some embodiments, the first scanning axis 219 is perpendicular to the second scanning axis 221.

In some embodiments, the incoupler 212 has a substantially rectangular profile and is configured to receive the laser light 218 and direct the laser light 218 into the waveguide 205. The incoupler 212 is defined by a smaller dimension (i.e., width) and a larger orthogonal dimension (i.e., length). In an embodiment, the optical relay 210 is a line-scan optical relay that receives the laser light 218 scanned in a first dimension by the first scan mirror 206 (e.g., the first dimension corresponding to the small dimension of the incoupler 212), routes the laser light 218 to the second scan mirror 208, and introduces a convergence to the laser light 218 in the first dimension to an exit pupil beyond the second scan mirror 208. Herein, an “exit pupil” in an optical system refers to the location along the optical path where beams of light intersect. For example, the possible optical paths of the laser light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the laser light corresponding to that exit pupil. Accordingly, the exit pupil can be considered a “virtual aperture.” According to various embodiments, the optical relay 210 includes one or more collimation lenses that shape and focus the laser light 218 on the second scan mirror 208 or includes a molded reflective relay that includes two or more spherical, aspheric, parabolic, and/or freeform lenses that shape and direct the laser light 218 onto the second scan mirror 208. The second scan mirror 208 receives the laser light 218 and scans the laser light 218 in a second dimension, the second dimension corresponding to the long dimension of the incoupler 212 of the waveguide 205. In some embodiments, the second scan mirror 208 causes the exit pupil of the laser light 218 to be swept along a line along the second dimension. In some embodiments, the incoupler 212 is positioned at or near the swept line downstream from the second scan mirror 208 such that the second scan mirror 208 scans the laser light 218 as a line or row over the incoupler 212.

The terms “incoupler” and “incoupler grating” are used to correspond with one another in this specification and the associated figures unless specifically indicated otherwise.

In some embodiments, the waveguide 205 includes a reflective structure to reflect light that is incoupled into the waveguide by the incoupler 212. The light that is reflected back into the waveguide from the reflective structure is referred to as the recycled portion (or, similarly, the recycled portion of light). In some embodiments, the reflective structure is arranged on an opposite side of the incoupler as the outcoupler, i.e., the outcoupler is arranged on or near one end of the waveguide and the reflective structure is arranged on or near the opposite end of the waveguide. Furthermore, in order to prevent the recycled portion from interacting with the incoupler, the reflective structure reflects the recycled portion back into the waveguide with a different polarization state (e.g., a second polarization state) from the original incoupled polarization state (e.g., a first polarization state). Additionally, a selective-polarization layer is included at the incoupler 212, either via the incoupler 212 itself or at an interface of a substrate of the waveguide 205 and the incoupler 212, to reflect the recycled portion with the different polarization state in order to prevent the recycled portion from being outcoupled at the incoupler.

In some embodiments, the optical engine 202 includes an edge-emitting laser (EEL) that emits a laser light 218 having a substantially elliptical, non-circular cross-section, and the optical relay 210 magnifies or minimizes the laser light 218 along its semi-major or semi-minor axis to circularize the laser light 218 prior to convergence of the laser light 218 on the second scan mirror 208. In some such embodiments, a surface of a mirror plate of the scan mirror 206 is elliptical and non-circular (e.g., similar in shape and size to the cross-sectional area of the laser light 218). In other such embodiments, the surface of the mirror plate of the scan mirror 206 is circular.

The waveguide 205 of the laser projection system 200 includes the incoupler 212 and the outcoupler 214. The term “waveguide,” as used herein, will be understood to mean a combiner using one or more of total internal reflection (TIR), specialized filters, and/or reflective surfaces, to transfer light from an incoupler (such as the incoupler 212) to an outcoupler (such as the outcoupler 214). In some display applications, the light is a collimated image, and the waveguide transfers and replicates the collimated image to the eye. In general, the terms “incoupler” and “outcoupler” will be understood to refer to any type of optical grating structure, including, but not limited to, diffraction gratings (e.g., binary diffractive gratings), holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the laser light 218 received at the incoupler 212 is relayed to the outcoupler 214 via the waveguide 205 using TIR. The laser light 218 is then output to the eye 216 of a user via the outcoupler 214. As described above, in some embodiments the waveguide 205 is implemented as part of an eyeglass lens, such as the lens 108 or lens 110 (FIG. 1) of the display system having an eyeglass form factor and employing the laser projection system 200.

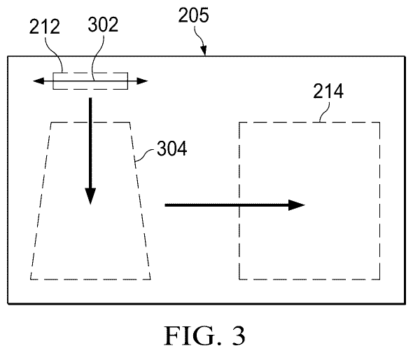

Although not shown in the example of FIG. 2, in some embodiments, additional optical components are included in any of the optical paths between the optical engine 202 and the scan mirror 206, between the scan mirror 206 and the optical relay 210, between the optical relay 210 and the scan mirror 208, between the scan mirror 208 and the incoupler 212, between the incoupler 212 and the outcoupler 214, and/or between the outcoupler 214 and the eye 216 (e.g., in order to shape the laser light for viewing by the eye 216 of the user). In some embodiments, a prism is used to steer light from the scan mirror 208 into the incoupler 212 so that light is coupled into incoupler 212 at the appropriate angle to encourage propagation of the light in waveguide 205 by TIR. Also, in some embodiments, an exit pupil expander (e.g., an exit pupil expander 304 of FIG. 3, described below), such as a fold grating, is arranged in an intermediate stage between incoupler 212 and outcoupler 214 to receive light that is coupled into waveguide 205 by the incoupler 212, expand the light, and redirect the light towards the outcoupler 214, where the outcoupler 214 then couples the laser light out of waveguide 205 (e.g., toward the eye 216 of the user).

FIG. 3 shows an example of light propagation within the waveguide 205 of the laser projection system 200 of FIG. 2 in accordance with some embodiments. As shown, light received via the incoupler 212, which is scanned along the axis 302, is directed into an exit pupil expander (EPE) 304 and is then routed to the outcoupler 214 to be output (e.g., toward the eye of the user). In some embodiments, the exit pupil expander 304 expands one or more dimensions of the eyebox of a WHUD that includes the laser projection system 200 (e.g., with respect to what the dimensions of the eyebox of the WHUD would be without the exit pupil expander 304). In some embodiments, the incoupler 212 and the exit pupil expander 304 each include respective one-dimensional diffraction gratings (i.e., diffraction gratings that extend along one dimension). It should be understood that FIG. 3 shows a substantially ideal case in which the incoupler 212 directs light straight down (with respect to the presently illustrated view) in a first direction that is perpendicular to the scanning axis 302, and the exit pupil expander 304 directs light to the right (with respect to the presently illustrated view) in a second direction that is perpendicular to the first direction. While not shown in the present example, it should be understood that, in some embodiments, the first direction in which the incoupler 212 directs light is slightly or substantially diagonal, rather than exactly perpendicular, with respect to the scanning axis 302.

In the example of FIG. 3, the incoupler 212 directs all or a substantial portion of the incoming light straight down in a first direction towards exit pupil expander 304. However, in many cases, a portion of the light that enters the waveguide 205 via the incoupler 212 is incoupled into the waveguide 205 in a direction opposite of the exit pupil expander 304 and the outcoupler 214. For example, if the incoupler 212 is a binary diffractive grating, some of (i.e., a portion) of the light received by the incoupler 212 may be directed away from the exit pupil expander 304 and the outcoupler 214. Accordingly, techniques to recycle this light back toward the exit pupil expander 304 and outcoupler 214 are described in further detail herein.

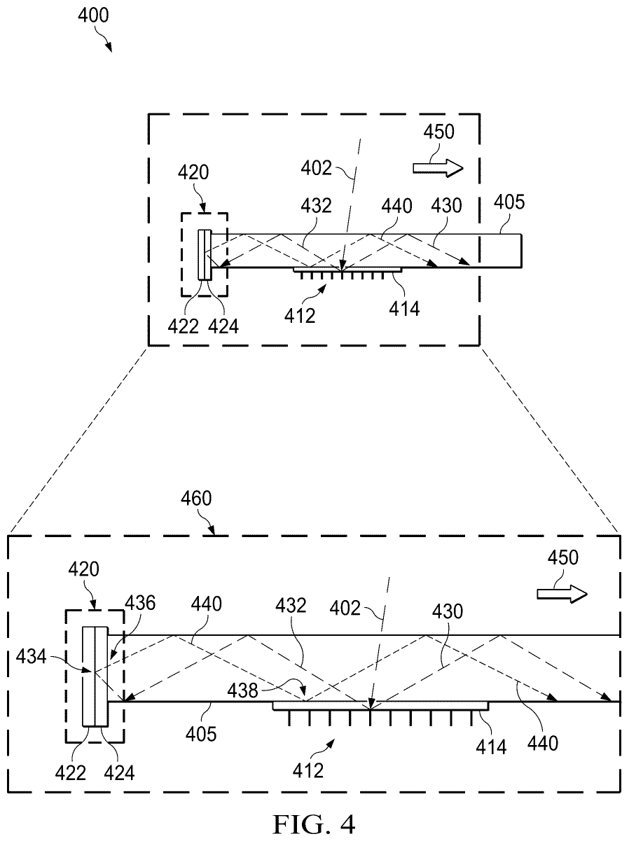

FIG. 4 illustrates a top view 400 of a portion of a waveguide substrate 405, such as one corresponding to waveguide 205 of FIG. 2, and a magnified view 460 of view 400 focusing on the paths of light in the waveguide substrate 405. In some embodiments, incoupler grating 412 is a diffractive incoupler grating such as a binary diffractive incoupler grating. Due to the nature of diffractive grating where incident light can be dispersed in multiple directions, a first portion of light 430 (primary portion) is propagated in a direction toward an exit pupil expander (EPE) and outcoupler (OC) 450, and a second portion 432 (which will be converted into the recycled portion 440) is propagated in a direction opposite of the EPE and OC 450.

A reflective structure 420, including mirror 422 and waveplate 424, reflects this second portion 432 of light so that it is redirected back toward the EPE and OC 450 as the recycled portion 440 to increase the amount of incoupled light that is directed toward the outcoupler. The reflective structure 420 is located on the opposite side of the incoupler grating 412 as the EPE and OC 450 (i.e., as shown in 400, the reflective structure 420 is to the left of incoupler grating 412 and the EPE and OC 450 are in a direction to the right). In some embodiments, the waveplate 424 is disposed between the mirror 422 and the waveguide substrate 405 and is a fractional waveplate such as a quarter waveplate (QWP) to change the polarization state (e.g., from a first polarization state to a second polarization state) of the light incident thereon. For example, the waveplate 424 changes the polarization state from P-polarization to S-polarization, or vice versa. In some embodiments, a polarization beam splitter (PBS) 414 is disposed between the incoupler grating 412 and the waveguide substrate 405. In this example, the PBS 414 reflects light of a second polarization state (e.g., the polarization state of the recycled portion 440) and transmits light of a first polarization state (e.g., the polarization state of the input light 402). The PBS 414 reflects the recycled portion 440 of the light to prevent outcoupling of the recycled portion 440 at the incoupler 412. Thus, the recycled portion 440 of light reflected by the reflective structure 420 continues to propagate within the waveguide substrate 405 toward the EPE and the OC 450 along with the primary portion 430.

As shown in magnified view 460, the input light 402 is received by the incoupler 412. The PBS 414 transmits light of the input light 402 polarization state (e.g., a first polarization state), thus allowing the incoupling of the input light 402 into the waveguide substrate 405. A first portion (primary portion) 430 of the input light 402 is incoupled by the incoupler 412 into the waveguide substrate 405 and directed toward the EPE and OC 450 (via TIR). Due to the nature of the diffractive grating of the incoupler 412, a second portion 432 of the input light 402 incoupled into the waveguide substrate 405 but in a direction away from the EPE and OC 450. This second portion 432 of light continues through the waveguide 405 (via TIR) until it reaches the reflective structure including mirror 422 and waveplate 424. The second portion 432 of light passes through the waveplate 424 and is reflected by the mirror 422 in the area marked by 434. This light is reflected back into the waveguide substrate 405 as the recycled portion 440 at point 436. Due to passing through the waveplate 424, the polarization state of the recycled light 440 is converted from the original polarization state (e.g., a first polarization state) to a different polarization state (e.g., a second polarization state). This change in polarization is illustrated by a transition from long dashed lines of the second portion 432 of light to the dotted lines of the recycled portion 440 of light in FIG. 4. The recycled portion 440 is guided back through the waveguide substrate 405 (via TIR) in the direction of the EPE and OC 450. At 438, the recycled portion 440 reflects off the PBS 414 and continues in the direction of the EPE and OC 450. The recycled portion 440 of light reflects off the PBS 414 due to having the converted polarization state. In this manner, both the primary portion 430 and the recycled portion 440 are directed toward the OC, thereby increasing the amount of incoupled light that is ultimately transmitted to the outcoupler.

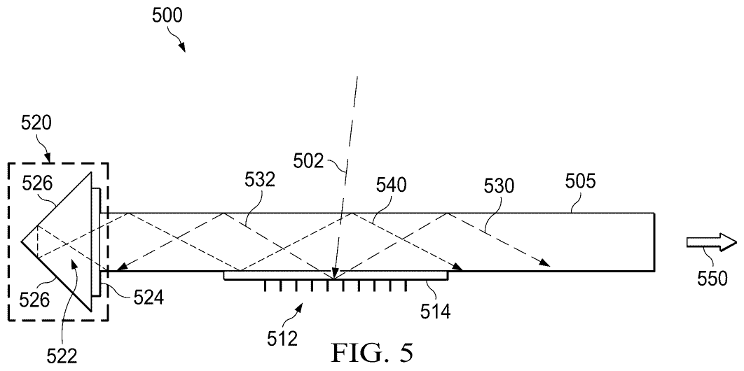

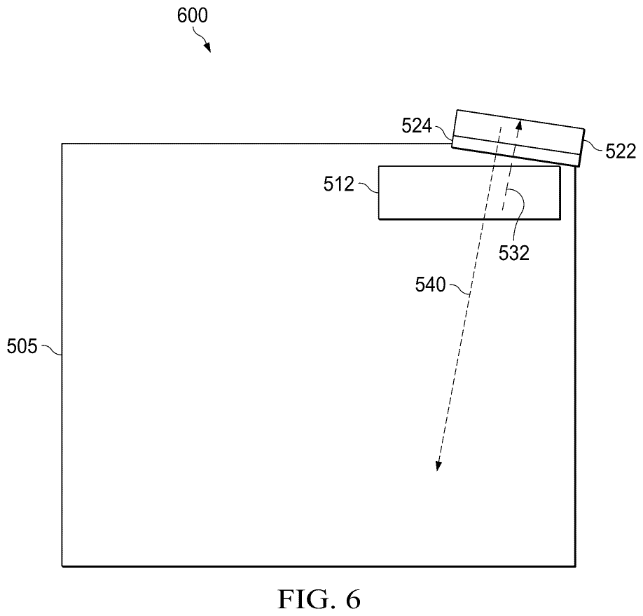

FIGS. 5-6 show a top view 500 and a side view 600 of a portion of a waveguide substrate 505, such as one corresponding to waveguide 205 of FIG. 2. In some embodiments, incoupler grating 512 is a diffractive incoupler grating such as a binary diffractive incoupler grating. Due to the nature of diffractive grating where incident light is dispersed in multiple directions, a first portion of light 530 (primary portion) is propagated in a direction toward an EPE and OC 550, and a second portion 532 (which will be converted into the recycled portion 540) is propagated in a direction opposite of the EPE and OC 550.

A reflective structure 520, including a prism 522 and waveplate 524, reflects this second portion 532 of light so that it is redirected back toward the EPE and OC 550 as the recycled portion 540 to increase the amount of incoupled light that is directed toward the outcoupler. The reflective structure 520 is located on the opposite side of the incoupler grating 512 as the EPE and OC 550 (i.e., as shown in 500, the reflective structure 520 is to the left of incoupler grating 512 and the EPE and OC 550 are in a direction to the right). The prism 522, in some embodiments, has a higher tolerance for position error than the flat mirror shown in FIG. 4. That is, the optical path of the reflected portion is less sensitive to the position of the prism 522, thereby simplifying the design and manufacture of the waveguide substrate 505.

In some embodiments, the prism 522 includes internal mirrored surfaces 526 that receive light from the waveguide substrate 405 through the waveplate 524 and reflect it back into the waveguide substrate 405 through the waveplate 524. For example, the prism 522 is a retroreflective right-angle prism. In some embodiments, the waveplate 524 is disposed between the prism 522 and the waveguide substrate 505 and is a fractional waveplate such as a quarter waveplate (QWP) to change the polarization state (e.g., from a first polarization state to a second polarization state) of the light incident thereon. For example, the waveplate 524 changes the polarization state from P-polarization to S-polarization, or vice versa. In some embodiments, a PBS 514 is disposed between the incoupler grating 512 and the waveguide substrate 505. In this example, the PBS 514 reflects light of a second polarization state (e.g., the polarization state of the recycled portion 540) and transmits light of a first polarization state (e.g., the polarization state of the input light 502). The PBS 514 reflects the recycled portion 540 of the light to prevent outcoupling of the recycled portion 540 at the incoupler 512. Thus, the recycled portion 540 of light reflected by the reflective structure 520 continues propagating within the waveguide substrate 505 toward the EPE and the OC 550 along with the primary portion 530.

As shown in FIG. 5, the light paths follow a substantially similar pattern as those shown in FIG. 4 with a slight modification in the manner that the light is reflected by the prism 522 back into the waveguide substrate. As shown in FIG. 5, the second portion 532 of light enters the prism 522 from the waveguide substrate 505 through the waveplate 524 and is internally reflected twice by the mirrored surfaces 526 in the prism 522 before being directed back through the waveplate 524 and into the waveguide substrate 505 as the recycled portion 540 of light.

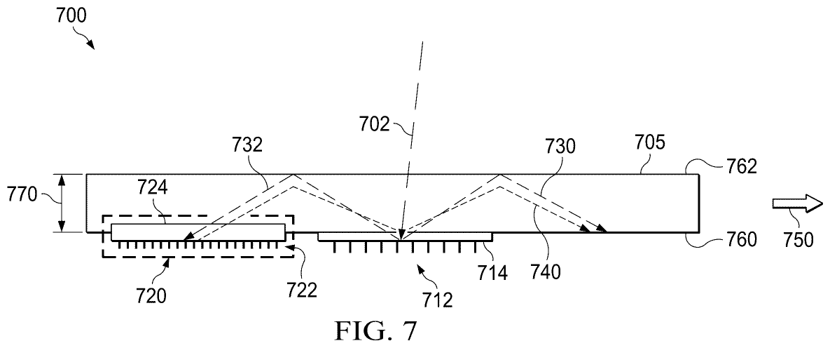

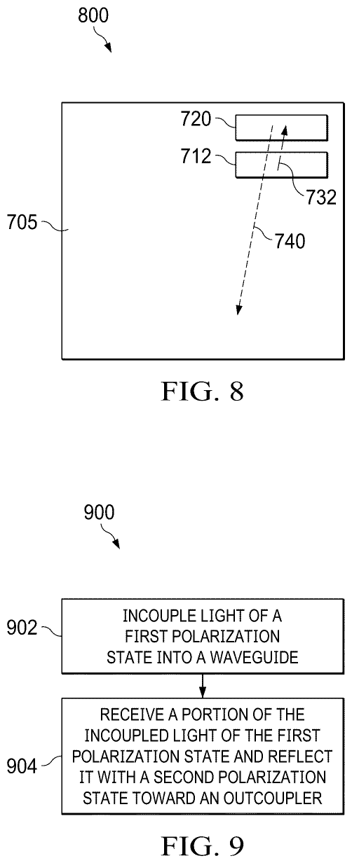

FIGS. 7-8 show a top view 700 and a side view 800 of a portion of a waveguide substrate 705, such as one corresponding to waveguide 205 of FIG. 2. In some embodiments, incoupler grating 712 is a diffractive incoupler grating such as a binary diffractive incoupler grating. Due to the nature of diffractive grating where incident light is dispersed in multiple directions, a first portion of light 730 (primary portion) is propagated in a direction toward an EPE and OC 750, and a second portion 732 (which will be converted into the recycled portion 740) is propagated in a direction opposite of the EPE and OC 750.

A reflective structure 720, including a fractional-pitch diffractive grating 722 and a waveplate 724, reflects this second portion 732 of light so that it is redirected back toward the EPE and OC 750 as the recycled portion 740 to increase the amount of incoupled light that is directed toward the outcoupler. The reflective structure 720 is located on the opposite side of the incoupler grating 712 as the EPE and OC 750 (i.e., as shown in 700, the reflective structure 720 is to the left of incoupler grating 712 and the EPE and OC 750 are in a direction to the right). The fractional-pitch diffractive grating 722 has a grating with a pitch that is a fraction (e.g., ½ ) of the pitch of the incoupler grating 712. In some embodiments, the application of the reflective structure 720 is facilitated since it is deposited over a larger surface area (i.e., a major face of the waveguide substrate 705 corresponding to side 760) compared with applying it over an end portion (i.e., area marked by 770) of the waveguide substrate 705. As shown in FIG. 7, the reflective structure 720 with the fractional-pitch diffractive grating 722 and waveplate 724 is applied to a same side 760 of the waveguide substrate 705 as the incoupler grating 712. However, in alternative embodiments, the reflective structure 720 with the fractional-pitch diffractive grating 722 and waveplate 724 is applied to the opposite side 762 of the waveguide substrate 705. In some embodiments, the determination of which side 760 or 762 to apply the reflective structure 720 to is based on manufacturing processes and considerations. In some embodiments, the waveplate 724 is disposed between the fractional-pitch diffractive grating 722 and the waveguide substrate 705 and is a fractional waveplate such as a quarter waveplate (QWP) to change the polarization state (e.g., from a first polarization state to a second polarization state) of the light incident thereon. For example, the waveplate 724 changes the polarization state from P-polarization to S-polarization, or vice versa. In some embodiments, a PBS 714 is disposed between the incoupler grating 712 and the waveguide substrate 705. In this example, the PBS 714 reflects light of a second polarization state (e.g., the polarization state of the recycled portion 740) and transmits light of a first polarization state (e.g., the polarization state of the input light 702). The PBS 714 reflects the recycled portion 740 of the light to prevent outcoupling of the recycled portion 740 at the incoupler 712. Thus, the recycled portion 740 of light reflected by the reflective structure 720 continues within the waveguide substrate 705 toward the EPE and the OC 750 along with the primary portion 730.

In some embodiments, the incoupler illustrated in FIGS. 4-8 is configured to be polarization sensitive. That is, the incoupler 412, 512, 712 is designed to transmit light of a first polarization state (e.g., corresponding to the input light) and reflect light of a second polarization state (e.g., corresponding to the recycled portion). Accordingly, in these embodiments, the PBS 414, 514, 714 at the interface of the incoupler and the waveguide substrate is not needed.

While the discussion above refers to incouplers with a diffractive grating, other incoupler types where a portion of the incoupled light is directed away from the EPE and OC are similarly covered by the scope of this disclosure.

FIG. 9 shows a flowchart 900 for a method, in accordance with some embodiments. The method includes, in 902, incoupling, via an incoupler, light of a first polarization state into a waveguide. The method includes, in 904, receiving, at a reflective structure, incoupled light of the first polarization state and reflecting it with a second polarization state toward an outcoupler. In some embodiments, the reflective structure is on an opposite side of the incoupler as the outcoupler. In some embodiments, the method includes converting the incoupled light of the first polarization state to the second polarization state via a waveplate in the reflective structure. In some embodiments, the method includes reflecting light of the second polarization state at an interface of the incoupler and a waveguide substrate of the waveguide.

Referring to FIGS. 1-9 the direction of incident light, grating features, and propagated light are depicted in the plane of the page for clarity. However, the direction of some or all of the light paths and/or features may be in or out of the plane of the page. Further, the techniques and systems described above are applicable to linescan MEMS relay system, as well as to 2-D optical relay systems.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A waveguide comprising:
an incoupler to incouple light of a first polarization state; and
a reflective structure to receive incoupled light of the first polarization state and reflect it with a second polarization state toward an outcoupler.

2. The waveguide of claim 1, wherein the reflective structure is on an opposite side of the incoupler as the outcoupler.

3. The waveguide of claim 1, wherein the incoupler transmits light of the first polarization state and reflects light of the second polarization state.

4. The waveguide of claim 1, further comprising a polarization beam splitter layer at an interface between the incoupler and a waveguide substrate of the waveguide.

5. The waveguide of claim 4, wherein the polarization beam splitter layer transmits light of the first polarization state and reflects light of the second polarization state.

6. The waveguide of claim 1, wherein the reflective structure comprises a diffractive grating with a fractional pitch of a grating of the incoupler.

7. The waveguide of claim 6, wherein the fractional pitch is half of a pitch.

8. The waveguide of claim 6, wherein the reflective structure comprises a waveplate to convert light of the first polarization state to the second polarization state.

9. The waveguide of claim 6, wherein the diffractive gating is on a same surface of a waveguide substrate of the waveguide as the incoupler.

10. The waveguide of claim 1, wherein the reflective structure comprises a prism.

11. The waveguide of claim 10, wherein the prism is a right-angle prism with mirrored internal surfaces.

12. The waveguide of claim 10, wherein the reflective structure comprises a waveplate to convert light of the first polarization state to the second polarization state.

13. The waveguide of claim 1, wherein the reflective structure comprises a mirror.

14. The waveguide of claim 13, wherein the reflective structure comprises a waveplate to convert light of the first polarization state to the second polarization state.

15. The waveguide of claim 1, wherein the incoupler comprises a binary diffractive incoupler grating.

16. A method comprising:
incoupling, via an incoupler, light of a first polarization state into a waveguide; and
receiving, at a reflective structure, incoupled light of the first polarization state and reflecting it with a second polarization state toward an outcoupler.

17. The method of claim 16, wherein the reflective structure is on an opposite side of the incoupler as the outcoupler.

18. The method of claim 16, further comprising converting the incoupled light of the first polarization state to the second polarization state via a waveplate in the reflective structure.

19. The method of claim 18, further comprising reflecting light of the second polarization state at an interface of the incoupler and a waveguide substrate of the waveguide.

20. The method of claim 16, wherein the incoupler comprises a binary diffractive incoupler grating.
